(19) United States
(12) Patent Application Publication
(10) Pub. No.: US 2006/0242156 A1
(43) Pub. Date: Oct. 26, 2006

(54) Communication path management system

(76) Inventors: Thomas W. Bish, Tucson, AZ (US); Joseph S. Hyde II, Tucson, AZ (US); Matthew J. Kalos, Tucson, AZ (US); Richard A. Ripberger, Tucson, AZ (US); John A. Staubi, Red Hook, NY (US); Kenneth M. Trowell, Poughkeepsie, NY (US); Harry M. Yudenfriend, Poughkeepsie, NY (US)

Correspondence Address: QUARLES & BRADY STREICH LANG LLP, 1 SOUTH CHURCH AVENUE, SUITE 1700, TUCSON, AZ, 85701, US

(21) Appl. No.: 11/110,553

(22) Filed: Apr. 20, 2005

(51) Int. Cl. G06F 17/30; G06F 7/00

(52) U.S. Cl. 707/10

(57) ABSTRACT

A communication-path management system includes a path-detection component for identifying all communications paths between a host computer, through a controller, to a data storage device. Once identified, the communication paths are incorporated into a logical-path mask. The path-detection component recognizes each path as either preferred or non-preferred based on latency, bandwidth, availability, or other user-defined criteria and divides the logical-path mask into a preferred path subset and a non-preferred path subset. If a valid path exists in the preferred path subset, all communications from the host computer to the data storage device transit paths belonging to this subset. Otherwise, active control is given to the non-preferred path subset. A channel subsystem manages actual communication based on resource allocation and contention using the currently active subset.

### BACKGROUND OF THE INVENTION

1. Field of the Invention

This invention is related in general to the field of data storage systems. In particular, the invention consists of a method for accessing data storage devices.

2. Description of the Prior Art

In FIG. 1, a computer storage system 10 includes host servers (“hosts”) 12, data processing servers 14, data storage systems 16 such as redundant arrays of inexpensive/independent disks (“RAIDs”), and a data communication system 18. Requests for information traditionally originate with the hosts 12, are transmitted by the communication system 18, and are processed by the data processing servers 14. The data processing servers retrieve data from the data storage devices 20 over a second data communication system 22 and transmit the data back to the hosts 12 through the first communication system 18. Similarly, the hosts 12 may write data to the data storage systems 16. The Data Processing Server 14 may include an individual computing device or a cluster of computer processors 24.

The communication system 18 may be a communication bus, a point-to-point, or switch point-to-point network, a fiber channel-arbitrated loop, or other communication scheme. The hosts 12 typically include host adapters 26 and the data processing servers usually include controller adapters 28 to interface with the communication system 18. The data storage devices 20 are logical units referred to as open devices. These logical units may consist of hard disk drives, tape cartridges, magneto-optical devices, or other memory devices. If the computer storage system includes more than one cluster 24, each cluster is typically designated as the primary management device for a subset of the data storage devices 20. However, if a host 12 is connected to a single cluster 24, and that cluster fails, any communication paths established between the host and the failing cluster's subset of data storage devices will be severed.

One approach to this problem is to implement multiple redundant connections between the host and the data processing server, as illustrated in FIG. 2. This particular computer storage system 30 incorporates a plurality of hosts 32 and a controller 34 including a plurality of clusters 36. Each host includes a separate host adapter 38 discretely connected to more than one cluster through a control adapter 40. Each cluster 36 acts as the primary management device for each subset 42 of data storage devices 44 through a primary connection 46. A secondary connection 48 may be used to connect each subset 42 of data storage devices 44 to a back-up cluster. In this way, a failure of a single host adapter 38, a control adapter 40, a cluster 36, or primary connection 46 will not prevent a host 32 from accessing a data storage device 42.

Previous generations of data storage system have been designed around the assumption that all communication channels that are defined between a host and a data storage device will have equivalent accessibility in terms of input/output response time and data bandwidth. Accordingly, exceptional expense and effort has been dedicated to designing controllers 34 that provide equal access to all data storage devices 42 from all host adapters 38.

In a departure from traditional systems, new generations of controllers are being designed that no longer provide equivalent access over all host adapters. These new designs allow significant cost reductions. This requires new methods of managing access to data storage devices that will optimize system performance and provide high availability in case of a path failure. The small-computer systems interface (“SCSI”) protocol utilizes asymmetric adapters where the host is required to manage the paths used for optimal system performance and availability. However, the SCSI protocol does not address issues related to dynamic pathing capability. For example, one architecture input/output consists of a series/set of channel command words executed in order. Each channel command word in the series is an independent command that may encounter conditions that require the input/output operation to disconnect from the channel. In this example, a channel program would disconnect if a cache miss was encountered. Instead of consuming the channel resources while waiting for the cache miss to get resolved, the device would disconnect to allow other input/output operations to continue. When the cache miss is resolved, the channel program would reconnect and the channel program would resume. When the dynamic pathing feature is supported, this reconnection may occur up a different path than that was executing the channel program when the disconnection took place. Accordingly, it is desirable to have a system of providing asymmetrical access to data storage devices that may be dynamically controlled to allow for component failure.

A recent solution comprises selecting a path to one of at least two controllers wherein each controller is capable of providing access to storage areas such as Logical Unit Numbers (“LUNs”). Path information is received from the controllers indicating a preferred controller to use to access each storage area. An input/output command directed to a target storage area is processed and the input/output command is directed to the controller indicated in the path information as the preferred controller for the target storage area. One controller is designated as the preferred controller and another as a non-preferred controller. The requesting computer initially sends an input/output command to the preferred controller and sends the input/output command to the non-preferred controller if the preferred controller cannot execute the input/output command.

### SUMMARY OF THE INVENTION

The invention disclosed herein utilizes a two-tiered management scheme to control communications between hosts, controllers, and data storage devices. The first tier includes a plurality of dynamically generated logical path masks that subset all the online paths to a data storage device into either a preferred group or a non-preferred group. The second tier of the invention is a channel subsystem that manages input/output initiation over a subset of paths based on resource utilization and contention. The result is an autonomic two tier path management methodology that optimizes system performance and provides high availability in case of a path failure.

A host computer defines all communication paths to a data storage device and creates a logical path mask (“LPM”). In one architecture, the I/O configuration is defined to the host, not discovered from the fabric. However, each defined I/O device is queried over each defined I/O path in order to discover its attributes. These attributes include what type of device it is, what its serial numbers are over each i/o interface, and the characteristics of each interface. The characteristics of each interface include whether preferred pathing must be used, and if so, whether the path is preferred or non-preferred. Additionally, the device may indicate that preferred pathing should optionally be used based on the characteristics of the I/O request. For example, if the I/O request will read in more than half a track of data, or the I/O request specifies that the cache should be pre-loaded with a sequential prefetch of the data based on what is currently being read, then a preferred path should be requested for the I/O operation. Host software recognizes and classifies each path as either a preferred or non-preferred path based on latency, bandwidth, availability, or other user-defined criteria. The host software divides the LPM into subsets of preferred and non-preferred paths. While all input/output operations are executable on all paths, these commands are only issued over the currently active subset of paths.

If a preferred path exists in the preferred path subset, a channel subsystem will issue input/output commands over one or more of the preferred paths based on resource utilization and contention. The host software will switch the active subset from the preferred to the non-preferred when the last preferred path has failed. The channel subsystem will then manage input/output commands over the subset of non-preferred paths. Whenever a valid preferred path is detected by the host computer, the host software activates the preferred subset of paths and the channel subsystem resumes management of input/output commands over the subset of preferred paths. Whenever additional bandwidth is required, the channel subsystem will distribute the workload over paths within whichever subset is currently active.

An established path may have its path attribute dynamically changed by the control unit at any time. The control unit signals the host via a unit check with special sense data to indicate when this has occurred. The unit check may be solicited or unsolicited by the host.

Another aspect of the invention requires that when the control unit disconnects while operating over a specific path, the reconnection by the control unit must occur on a path with matching attributes. This means that if the control unit was executing the I/O operation on a preferred path when it disconnected, the reconnection status must be on a path that is also preferred. Likewise, if the operation was executing on a path that was non-preferred when it disconnected, the reconnection must occur on a non-preferred path.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is a block diagram illustrating a computer storage system including host servers, data processing servers, data storage devices, and a data communication system.

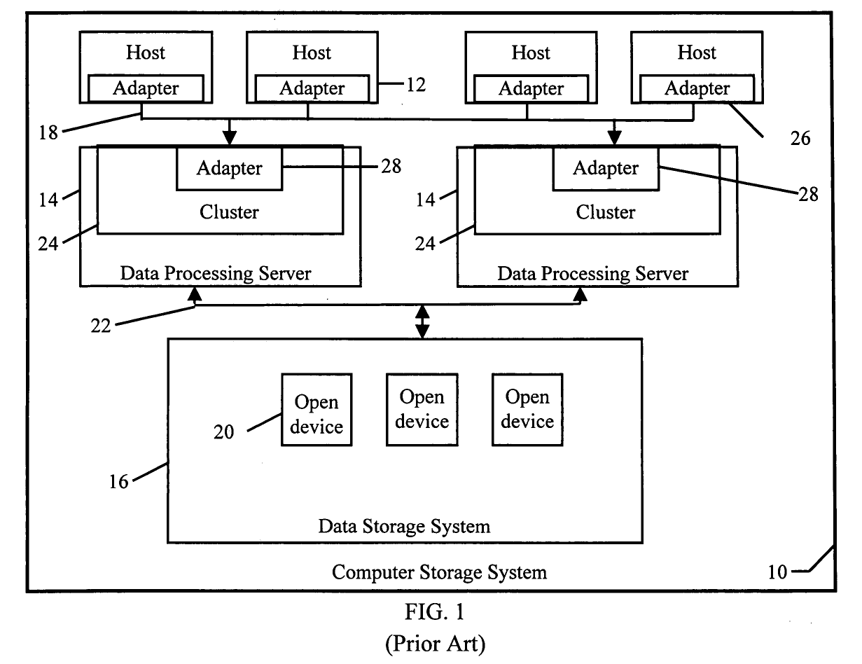

FIG. 2 is a block diagram illustrating a computer storage system similar to the one of FIG. 1 with redundant communication paths between host servers and data storage devices.

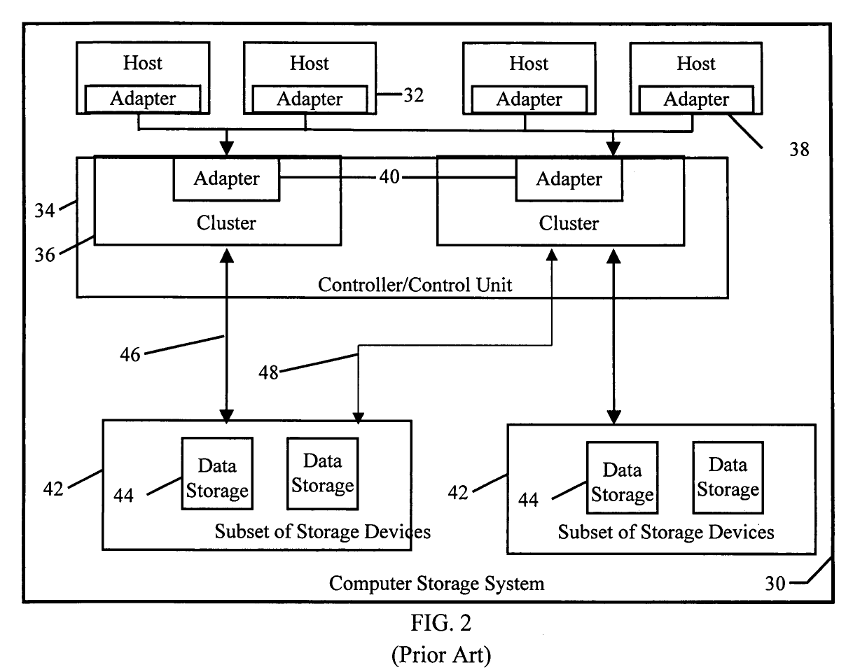

FIG. 3 is a block diagram of a communication-path management system according to the invention including a two-tiered management scheme for controlling input/output requests from host servers to data storage devices.

FIG. 4 is a block diagram of a host computer including a two-tiered management system according to the invention.

FIG. 5 is a flow chart illustrating a path-control algorithm according to the invention.

### DESCRIPTION OF THE PREFERRED EMBODIMENTS

This invention is based on the idea of using a two-tiered management scheme to control input/output requests from host computers to data storage devices. The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (“FPGAs”), application-specific integrated circuits (“ASICs”), complex programmable logic devices (“CPLDs”), programmable logic arrays (“PLAs”), microprocessors, or other similar processing devices. A processing device may include a host computer or host system.

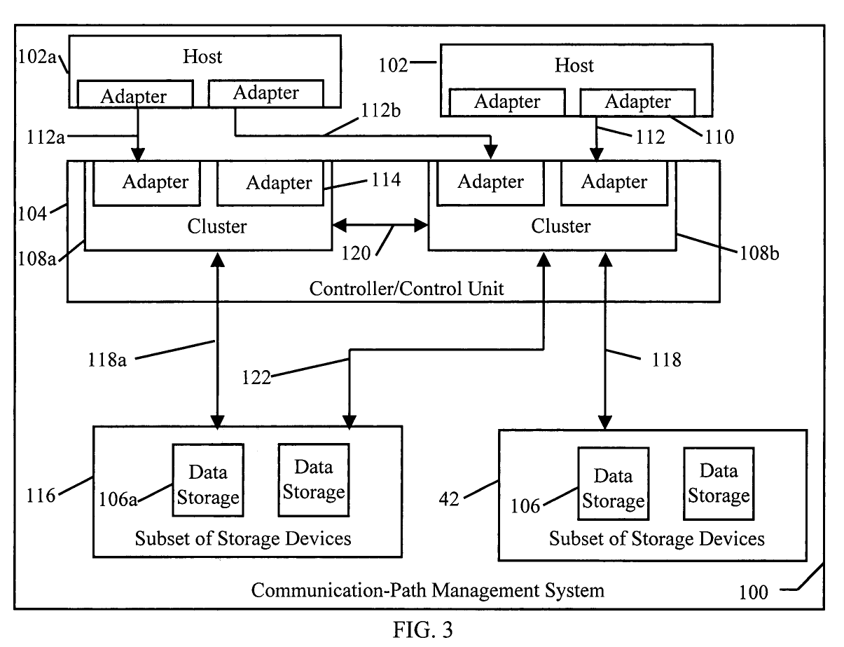

Referring to figures, wherein like parts are designated with the same reference numerals and symbols, FIG. 3 is a block diagram illustrating a communication-path management system 100 including a plurality of host computers 102, a controller 104, and a plurality of data storage devices 106. The controller 104 includes a plurality of clusters 108. Each host 102 includes a plurality of host adapters 110 discretely connected to a plurality of clusters 108 through a first communication channel 112 and a plurality of control adapters 114.

Each cluster 108 is responsible for actively managing communication with a subset 116 of data storage device 106 over a second communication channel 118. In order to provide redundancy, the controller 104 includes a cross-cluster bus 120 and redundant communication channels 122 between data storage devices and non-primary clusters.

Preferred communications paths exist between the hosts 102 and the data storage devices 44 based on latency, bandwidth, availability, or other user-definable criteria. An exemplary preferred communication path may exist between a first host 102a, through a first communication channel 112a, through a first cluster 108a, through a second communication channel 118a, and a first data storage device 106a. An exemplary non-preferred path may exist between the same host 102a, through an alternate communication channel 112b, through a second cluster 108b, through the cross-cluster bus 120, through the second communication channel 118a, and the first data storage device 106a. Yet another non-preferred path may exist between the host 102a, through the alternate communication channel 112b, through the second cluster 108b, through the redundant communication channel 122, and the first data storage device 106a.

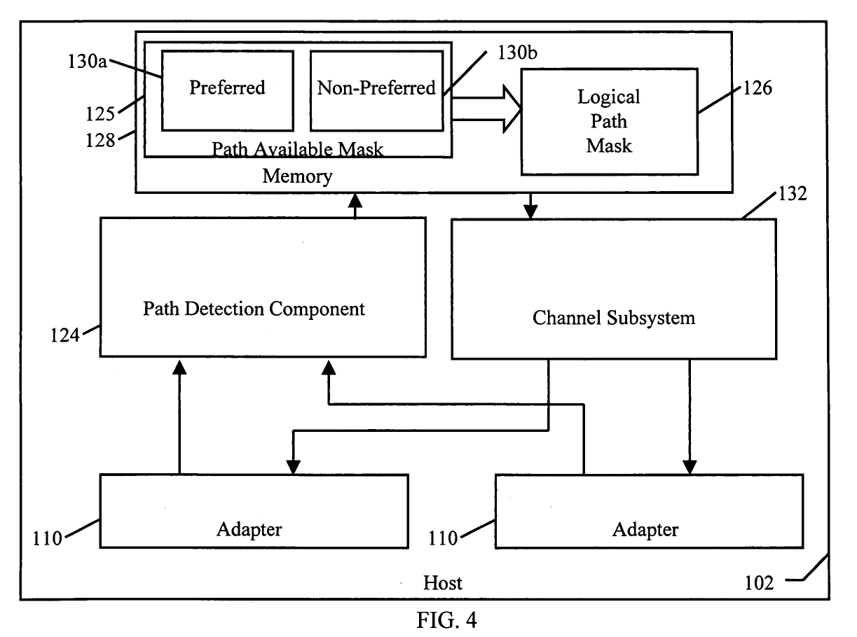

A two-tiered communication management system is illustrated by the block diagram of FIG. 4 more fully illustrating the host 102 of FIG. 3. The first element, instituted as either a hardware device or a software algorithm, is a path-detection component 124. The path-detection component 124 is responsible for recognizing all paths between the host 102 and all accessible data storage devices 106. To facilitate this, the controller 104 may provide path information to the host 102. The path-detection component 124 creates a path available mask (“PAM”) 125, stored in a memory device 128, that describes which paths are available. The path-detection component 124 identifies each path included in the PAM as being either preferred or non-preferred based on pre-defined criteria. Additionally, the path-detection component 124 creates a logical-path mask (“LPM”) 126 which is a subset of the PAM used for a particular operation based on user-defined criteria. This user-defined criteria may include latency or size of the data transfer requested in the channel program. When the software requests that an I/O operation be started, it will select whether to use preferred paths or not based on the characteristics of the channel program. The appropriate LPM is passed to the channel subsystem to initiate the I/O request. The channel subsystem will select which path to use among the paths specified in the LPM passed along with the I/O operation. This allows for an input/output request that meets certain criteria to use all paths while other input/output requests to be limited to preferred paths only.

The pathing information provided by the controller may also be used to aid the host 102 in this process. Once the path attributes (preferred/non-preferred) have been identified, the path-detection component divides the PAM into subsets 130a,130b of preferred and non-preferred paths. An input/output request requiring high bandwidth may be limited to preferred paths while low-latency operations may be dispatched to all paths in the PAM. Optionally, all input/output requests may be limited to paths included in the preferred path subset, if any such paths are valid.

Deciding whether to use preferred pathing or not depends on the nature of the cross-cluster bus. For example, transfers over a particular size, or read vs. write operations, or the latency added by traversing the bus will all vary based on controller design. The data needed to make that determination is returned by the controller.

In one implementation of the invention, a controller can disconnect from a path in the middle of an input/output operation and be reconnected on a different path. This reconnection must adhere to reconnection rules. For example, the controller can pick the reconnection path without input from the host. If the input/output operation began on a preferred path, then the reconnection must occur on a preferred path. If the input/output operation began on a non-preferred path, then the reconnection may occur on any path. Alternatively, the host can provide information in the input/output request that tells the controller whether or not to only utilize preferred paths for reconnection.

If any paths currently reside in the preferred path subset 130a, this subset is active and all communication requests to the associated data storage device are transmitted through this subset's paths. However, if no valid paths exist in the preferred path subset 130a, communication requests are transmitted through the paths of the non-preferred subset 130b. Once a valid preferred path is placed in the preferred path subset 130a, control is transitioned from the non-preferred subset 130b back to the preferred subset 130a.

An established path residing in one subset 130a,130b may be moved to the other subset if its classification, according to the user-defined criteria, changes.

Once an I/O operation executing on an established path has been physically disconnected, the control unit must limit the reconnection to occur over a path with the same attributes as when the path disconnected.

While the path-detection component 124 is responsible for creating the subsets 130a,130b of preferred and non-preferred paths and determining which subset is currently active, a channel subsystem 132 manages input/output requests using the active subset based on resource utilization and contention. A simple communication request may transit a single communication path. However, more bandwidth-intensive communication requests may be distributed over a plurality of communication paths. However, while all input/output operations are executable on all communication paths, only those paths within the currently active subset may be used.

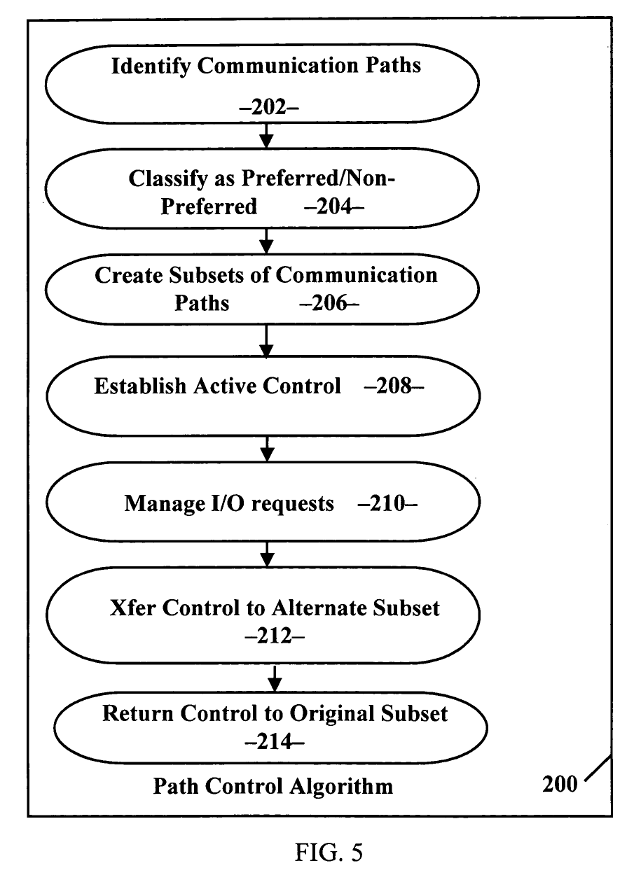

A path-control algorithm 200 is illustrated by the flow chart of FIG. 5. In step 202, a path-detection component 124 identifies all communication paths between a host 102 and a data storage device 106 and creates a logical path mask (“LPM”). The communication paths are classified as either preferred or non-preferred in step 204 and grouped into preferred and non-preferred subsets in step 206. In step 208, active control is given to the preferred-path subset. In step 210, the channel subsystem manages communication requests from the host 102 to the data storage device 106 using one or more communication paths selected from the currently active subset. In optional step 212, control switches from the preferred subset 130a to the non-preferred subset 130b if no valid paths exist in the preferred subset. In step 214, control is returned to the preferred subset 130a whenever the first valid preferred path is established.

Those skilled in the art of making computer storage systems may develop other embodiments of the present invention. However, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

We claim:

1. A communication-path management system, comprising:
a data storage device;
a controller including a first processing cluster, said controller connected to said data storage device through a first communication channel; and
a host computer including a path-detection component, said host computer connected to said controller through a second communication channel, wherein said path-detection component identifies a first set of communication paths including preferred and non-preferred paths available between the host computer and the data storage device and identifies a second set of communication paths taken from the first set of communication paths based on user-defined criteria.

2. The communication-path management system of claim 1, wherein the path-detection component is adapted to create a logical-path mask representative of the second set of communication paths.

3. The communication-path management system of claim 2, wherein the path-detection component is adapted to create a subset of preferred paths including the one or more preferred paths.

4. The communication-path management system of claim 3, wherein the path-detection component is adapted to make the subset of preferred paths active if at least one valid communication path exists in the subset of preferred paths.

5. The communication-path management system of claim 4, wherein the host computer further includes a channel subsystem for managing input/output requests from the host computer to the data storage device.

6. The communication-path management system of claim 5, wherein the channel subsystem transmits said input/output requests over at least one of the subset of preferred paths.

7. The communication-path management system of claim 5, wherein the channel subsystem transmits said input/output requests over at least one non-preferred path if no valid communication path exists in the subset of preferred paths

8. The communication-path management system of claim 7, wherein the path-detection component is adapted to recognize said one or more preferred paths from the first set of communication paths based on preferred criteria.

9. The communication-path management system of claim 8, wherein said preferred criteria includes latency.

10. The communication-path management system of claim 8, wherein said preferred criteria includes bandwidth.

11. The communication-path management system of claim 8, wherein the user-defined criteria includes whether to applied to preferred criteria to a current input/output request.

12. A processing device adapted to perform the steps of:
identifying one or more communication paths from a host computer to a data storage device;
classifying each of said one or more communication paths as either a preferred communication path or a non-preferred communication path;
creating a subset of preferred communications paths including each preferred communication path;
creating a subset of non-preferred communication paths including each non-preferred communication path;
setting the subset of preferred communication paths as an active set of communication paths if a valid communication path is present in the subset of preferred communication paths; and
transmitting input/output requests from the host computer to the data storage device using one or more communication paths included in the active set of communication paths.

13. The processing device of claim 12, further adapted to perform the steps of:
creating a subset of non-preferred communication paths including each non-preferred communication path; and
setting the subset of non-preferred communication paths as the active set of communication paths if a valid communication path is not present in the subset of preferred communication paths.

14. The processing device of claim 12, wherein the step of classifying each of said one or more communication paths as either a preferred communication path or a non-preferred communication path is based on user-defined criteria.

15. The processing device of claim 14, wherein said user-defined criteria includes latency.

16. The processing device of claim 14, wherein said user-defined criteria includes bandwidth.

17. An article of manufacture including a data storage medium, said data storage medium including a set of machine-readable instructions that are executable by a processing device to implement an algorithm, said algorithm comprising the steps of:
identifying one or more communication paths from the processing device to a data storage device;
classifying each of said one or more communication paths as either a preferred communication path or a non-preferred communication path;
creating a subset of preferred communications paths including each preferred communication path;
creating a subset of non-preferred communication paths including each non-preferred communication path;
setting the subset of preferred communication paths as an active set of communication paths if a valid communication path is present in the subset of preferred communication paths; and
transmitting input/output requests from the host computer to the data storage device using one or more communication paths included in the active set of communication paths.

18. The article of manufacture of claim 17, further comprising the steps of:
creating a subset of non-preferred communication paths including each non-preferred communication path; and
setting the subset of non-preferred communication paths as the active set of communication paths if a valid communication path is not present in the subset of preferred communication paths.

19. The article of manufacture of claim 17, wherein the step of classifying each of said one or more communication paths as either a preferred communication path or a non-preferred communication path is based on user-defined criteria.

20. The article of manufacture of claim 19, wherein said user-defined criteria includes latency.
